(19) United States
(12) Patent Application Publication
(10) Pub. No.: US 2012/0059142 A1
(43) Pub. Date: Mar. 8, 2012

(54) PREPARING POLYESTER ALCOHOLS

(75) Inventors: Hermann Graf, Mutterstadt (DE); Ulrike Mahn, Mannheim (DE); Stefan Käshammer, Schifferstadt (DE); Günter Scherr, Ludwigshafen (DE); Christian Nitschke, Speyer (DE)

(73) Assignee: BASF SE, Ludwigshafen (DE)

(21) Appl. No.: 13/226,213

(22) Filed: Sep. 6, 2011

Related U.S. Application Data
(60) Provisional application No. 61/380,338, filed on Sep. 7, 2010.

(51) Int. Cl. C08G 63/85; C08G 63/181

(52) U.S. Cl. 528/279; 528/274

(57) ABSTRACT

A process for preparing polyester alcohols by condensation of polytetrahydrofuran with aromatic dicarboxylic acids and/or their anhydrides and/or their esters, preferably isophthalic acid, phthalic acid and terephthalic acid and more preferably isophthalic acid, in the presence of a transesterification catalyst in a multi-stage operation at different pressure levels with at least one reaction stage at atmospheric pressure and at least one reaction stage at reduced pressure, where distillate is removed from the reaction system, comprises deactivating the catalyst after the polycondensation by using phosphoric acid in a molar ratio of 1:1 to 1:3.5 for catalyst to phosphoric acid.

### CROSS-REFERENCE TO RELATED APPLICATION

This patent application claims the benefit of pending U.S. provisional patent application Ser. No. 61/380,338 filed Sep. 7, 2010 incorporated in its entirety herein by reference.

### FIELD OF THE INVENTION

This invention relates to a process for preparing polyester alcohols based on polytetrahydrofuran and dicarboxylic acid and also to the use of these polyester alcohols for preparing polyurethaneurea-based elastic fibers (elastane, or synonymously spandex) having a particularly flat hysteresis curve, known in the literature as “soft elastane” or “soft spandex”. Elastane fibers are described for example in H. J. Koslowski, “Dictionary of Man-Made Fibers”, 1st edition 1998, International Business Press Publishers GmbH, Frankfurt am Main, p. 69 et seq.

### BACKGROUND

Preparing polyester alcohols, also known as polyesterols, by polycondensation reactions of polybasic carboxylic acids with polyhydric alcohols, or polyols, has been extensively described. By way of example there may be cited the Kunststoffhandbuch, volume VII, Polyurethane, Carl-Hanser-Verlag, Munich 1st edition 1966, edited by Dr. R. Vieweg and Dr. A. Höchtlen, and also 2nd edition 1983 and the 3rd revised edition 1993, edited by Dr. G. Oertel.

Using these polyesterols particularly in the manufacture of polyurethane (PU) products, more particularly elastic fibers based on polyurethaneurea, which have a particularly flat hysteresis curve, requires careful choice of the materials used and of the polycondensation technology to be applied. It is known to use aromatic and/or aliphatic dicarboxylic acids/anhydrides and di-, tri- and/or polyfunctional alcohols, more particularly glycols, which are made to react at temperatures of particularly 150-250° C. under atmospheric pressure and/or reduced pressure in the presence of catalysts by removing the water of reaction. The customary technology, described in DE-A-2904184 for example, is to add the reaction components at synthesis commencement with a suitable catalyst coupled with concurrent raising of the temperature and lowering of the pressure. The temperatures and the vacuum are then further changed in the course of the synthesis.

When the polycondensation reaction involves multiple acids and/or alcohols, individual reaction materials may also only be added in the course of the reaction. Usually, the condensation reaction is carried out under atmospheric pressure or slightly reduced pressure up to the removal of the low-boiling components (water, methanol). After the evolution of low boilers has ended, still other reaction components are then added if appropriate, temperature changes are made and the beginning of the vacuum phase is shifted toward the high-vacuum phase.

Polyurethane fibers are produced from the thus obtained polyester alcohols by reaction with a diisocyanate to form an isocyanate-terminated prepolymer which, in a further reaction with a chain extender, optionally a chain terminator and optionally further additives, in a suitable solvent is converted to the polyurethane elastomer. In the last step, the polyurethane elastomer is spun into fiber by removing the solvent which, in a widely used dry-spinning process, can be dimethylacetamide, dimethylformamide or N-methylpyrrolidone for example.

When a catalyst is used in the polycondensation of dicarboxylic acid and polyol, more particularly polytetrahydrofuran, it is generally added in such a low concentration that it does not interfere with the subsequent processing steps, or—once the number average molecular weight Mn desired for the polyester alcohol has been reached—deactivated by addition of a deactivating reagent, phosphoric acid for example, in order that it may not impair the subsequent reaction with diisocyanate to form the prepolymer.

Deactivation of the catalyst is ideally complete since the reactivity of the polyester has direct repercussions on the properties, more particularly the viscosity, of the isocyanate-terminated prepolymer produced in the next step of the fiber-manufacturing operation. When the reactivity of the polyesterol in the prepolymer reaction is too high, the resulting heat of reaction cannot be removed fast enough, causing the reaction mixture to heat up above the maximum permissible temperature. Above this temperature there is an increasing occurrence of secondary reactions, particularly crosslinking, which can increase the viscosity of the polyurethane elastomer solution to such an extent that the batch is no longer spinnable.

### BRIEF SUMMARY

It is an object of the present invention to develop a process for preparing polyester polyalcohols based on polytetrahydrofuran and aromatic dicarboxylic acids and/or their anhydrides and/or their esters whereby polyester polyalcohols based on polytetrahydrofuran and aromatic dicarboxylic acids are simple and economical to prepare with high functionality. The purpose is thus to prepare a polyester polyalcohol combining high functionality with low reactivity. It must be borne in mind here that increasing the catalyst concentration to achieve run time shortening, and the resulting increase in functionality, leads to increased reactivity.

The present invention accordingly provides a process for preparing polyester alcohols by condensation of polytetrahydrofuran with aromatic dicarboxylic acids and/or their anhydrides and/or their esters, preferably isophthalic acid, phthalic acid and terephthalic acid and more preferably isophthalic acid, in the presence of a transesterification catalyst in a multi-stage operation at different pressure levels with at least one reaction stage at atmospheric pressure and at least one reaction stage at reduced pressure, where distillate is removed from the reaction system, which process comprises deactivating the catalyst after the polycondensation by using phosphoric acid in a molar ratio of 1:1 to 1:3.5 for catalyst to phosphoric acid.

### BRIEF DESCRIPTION OF THE DRAWINGS

FIG. 1 is a chart showing the decrease in NCO concentration over time

### DETAILED DESCRIPTION OF THE PREFERRED EMBODIMENTS

It was found that, surprisingly, the range for the molar ratio of catalyst to phosphoric acid that leads to deactivation is very narrow. Neither too much nor too little phosphoric acid leads to the desired effect. The molar ratio of catalyst to phosphoric acid is preferably in the range from 1:1.1 to 1:2.4 and more preferably in the range from 1:1 to 1:1.4.

The transesterification catalyst added may be for example tetrabutyl orthotitanate, tetraisopropyl orthotitanate, dibutyltin laurate, dibutyltin oxide, tin octoate, tin chloride, tin oxide, potassium hydroxide, sodium methoxide, titanium zeolites, lipases or hydrolases immobilized on carriers, preferably in a concentration of 3 to 100 ppm, more preferably in the concentration of 20 to 60 ppm and even more preferably in the concentration of 40 to 50 ppm. The preferred catalyst is tetrabutyl orthotitanate.

Preferably, tetrabutyl orthotitanate is added in polytetrahydrofuran having an average molecular weight of 250 to 1000 daltons and/or 1,4-butanediol as solvent. The concentration of the tetrabutyl orthotitanate in the solvent is in the range from 0.1% to 15% by weight and preferably in the range from 2% to 10%. However, the use of solvent is not essential.

The polyester alcohol is prepared by polycondensing isophthalic acid advantageously in a molar ratio of 1:0.9 to 1:0.5, preferably 1:0.8 to 1:0.7 and more preferably 1:0.75 with polytetrahydrofuran.

Polytetrahydrofuran (PTHF) is typically produced in industry, in a conventional manner, by polymerization of tetrahydrofuran—hereinafter abbreviated to THF—over suitable catalysts. Suitable reagents can be added to control the chain length of the polymer chains and hence the average molecular weight. Such reagents are known as chain-terminating reagents or “telogens”. It is through the choice of which telogen and which amount thereof that control is effected. Suitable telogens additionally enable functional groups to be introduced at one or both of the ends of the polymer chain. Industrially, acetic anhydride or water are frequently used as telogens. The process is described in the DE 19801462 patent for example.

The PTHF used in the process of the present invention preferably has an average molecular weight in the range from 250 to 3000 daltons and more preferably in the range from 250 to 2000 daltons, such as PTHF 250, PTHF 450, PTHF 650, PTHF 1800 and PTHF 2000. The preference is for an average molecular weight of 400-1000 daltons, preferably for 650 daltons. By “average molecular weight” or “average molar mass” herein is meant the number average Mₙ of the molecular weight of the polymers, determined by wet-chemical OH number determination for example.

Useful aromatic dicarboxylic acids have from 2 to 12 carbon atoms in particular. Useful dicarboxylic acids include for example: adipic acid, succinic acid, glutaric acid, suberic acid, azelaic acid, sebacic acid, decanedicarboxylic acid, maleic acid, fumaric acid, preferably adipic acid, phthalic acid, isophthalic acid, terephthalic acid and the isomeric naphthalenedicarboxylic acids. Dicarboxylic acids can be used not only alone but also mixed with each other. Instead of the dicarboxylic acids it is also possible to use the corresponding dicarboxylic acid derivatives, for example dicarboxylic esters of alcohols having 1 to 6 carbon atoms or dicarboxylic anhydrides. Preference is given to using dicarboxylic acid mixtures of succinic, glutaric and adipic acids in amount ratios of for example 20 to 35:35 to 50:20 to 32 parts by weight and adipic acid and more particularly mixtures of phthalic acid and/or phthalic anhydride and adipic acid, mixtures of phthalic acid/anhydride, isophthalic acid and adipic acid or dicarboxylic acid mixtures of succinic, glutaric and adipic acids and mixtures of terephthalic acid and adipic acid or dicarboxylic acid mixtures of succinic, glutaric and adipic acids. Preference is given to using aromatic carboxylic acids or mixtures comprising aromatic carboxylic acids. Particular preference is given to using isophthalic acid.

The reaction between polytetrahydrofuran and the aromatic dicarboxylic acid and/or anhydride is carried out under (trans)esterification conditions. The reaction mixture is gradually heated, for example to a temperature of 150 to 250° C., at which point a vacuum of <1013 to 5 hPa is applied, and resulting by-product is removed by distillation.

In a particularly preferred embodiment of the process of the present invention, polytetrahydrofuran is reacted with isophthalic acid in the presence of tetrabutyl orthotitanate in a multistage operation at different pressure levels with at least one reaction stage at atmospheric pressure and at least one reaction stage at reduced pressure, where distillate is removed from the reaction system, and the reaction mixture is heated in two or more phases in the atmospheric-pressure reaction stage wherein the heating phases are interrupted by at least one phase in which the temperature is kept constant.

The reaction mixture in the first heating phase is heated to a temperature T₁ where T₁=130 to 190° C., preferably 180, in the course of 0.1 to 15 h. In the first phase, the temperature T₁ can be reached by continuous heating (temperature ramping), or this temperature ramping may be interrupted by at least one phase of constant temperature delta T₁ (temperature plateau) where delta T₁ is preferably from 1 to 10° C. lower than T₁. The second heating phase takes the temperature, in the course of 1 to 20 h, to a temperature T_{end}=200 to 230° C., preferably 220° C. Again, this second phase can be reached by continuous heating to the end temperature of the atmospheric-pressure reaction stage T_{end}, or be interrupted by at least one phase of constant temperature delta T₂ (temperature plateau) where delta T₂ is preferably from 1 to 20° C. lower than T_{end}.

Preferably, the temperature between the heating phases to the end temperature of the atmospheric-pressure reaction stage (temperature-ramping phases) is twice kept constant, corresponding to two temperature plateaus. The temperature between the heating phases is preferably kept constant for two times 0.5 to 10 hours (h), preferably 1 to 5 h and more preferably 1 to 4 h.

The atmospheric-pressure reaction stage corresponds to the time for heating to Tₑ and is preferably carried out in an overall time of 2 to 15 hours and more preferably 2.5 to 8 hours.

The synthesis of the polyester alcohols is carried out under (trans)esterification conditions and can take place in a solvent. Preferably, when polytetrahydrofuran and aromatic dicarboxylic acids are reacted, no solvent is used.

To avoid oxidation and attendant loss of functionality, the condensation of polytetrahydrofuran with aromatic dicarboxylic acids, preferably isophthalic acid, phthalic acid and terephthalic acid and more preferably isophthalic acid, is advantageously carried out under an inert-gas atmosphere. Useful inert gases include, for example, nitrogen, carbon dioxide or noble gases, preference being given to nitrogen. The inert-gas atmosphere is intended to reduce the oxygen content of the reaction apparatus to less than 0.1% by volume.

The transesterification catalyst, for example tetrabutyl orthotitanate, tetraisopropyl orthotitanate, dibutyltin laurate, dibutyltin oxide, tin octoate, tin chloride, tin oxide, potassium hydroxide, sodium methoxide, titanium zeolites, lipases or hydrolases, immobilized on a carrier, preferably tetrabutyl orthotitanate, is preferably added from 2 to 4 h after attainment of temperature T_{end} and before application of the vacuum. Preferably, tetrabutyl orthotitanate is added in polytetrahydrofuran of an average molecular weight of 250 to 1000 daltons and/or 1,4-butanediol as solvent. The concentration of the titanium tetrabutyl orthotitanate in the solvent is from 1% to 15% by weight, preferably from 2% to 10% by weight and more preferably from 5% to 10% by weight. However, the use of solvent is not essential.

The reduced-pressure reaction stage is preferably carried out at a pressure <1013-2 mbar, preferably at from 2 to 100 mbar and more preferably at from 2 to 50 mbar.

The reduced-pressure reaction stage is preferably carried out in an overall time of 2 to 15 hours and more preferably from 2.5 to 8 hours.

The process of the present invention provides a distinct improvement in the manufacture of polyester alcohols evinced by high functionality and low reactivity.

The examples which follow illustrate the invention.

### EXAMPLES

### Molecular Weight Determination

The average molecular weight Mn in the form of the number average molecular weight, defined as the mass of all PTHF molecules divided by their amount in moles, is determined by determining the hydroxyl number in polytetrahydrofuran. The hydroxyl number is the amount of potassium hydroxide in mg which is equivalent to the amount of acetic acid bound in the course of the acetylation of 1 g of substance. The hydroxyl number is determined via the esterification of the existing hydroxyl groups with an excess of acetic anhydride.

H—[O(CH₂)₄]n-OH+(CH3CO)₂→CH₃CO—[O(CH₂)₄]n-O—COCH₃+H₂O

After the reaction, excess acetic anhydride is hydrolyzed with water in accordance with the following reaction equation:

(CH₃CO)₂O+H2O→2CH₃COOH

and backtitrated as acetic acid with potassium hydroxide.

### Determination of Viscosity

Viscosity was determined in accordance with DIN 53019-1 at 60° C. with a Physica MCR101 viscometer (mounted on an air bearing) from Anton Paar (millipascal second=mPas). The instrument has an Anton Paar Drypoint membrane dryer, Haake DC10 thermostat (water temperature controlled to 30° C.), a PC with Rheoplus/32 V3.10 software (connection via serial interface), a compressed-air supply (3 bar line). The liquid to be investigated is positioned in the measuring gap of the viscometer between the cone: Anton Paar CP50-1 and the plate: Anton Paar Peltier P-PTD 200 (cone-plate distance: 0.05 mm), of which one rotates at an angular velocity Ù (rotor) and the other is stationary (stator). (Time setting: 15 data points each involving 5 s of measurement (of that the instrument needs 2.5 s to adjust to the respective shear rate. In the next 2.5 s, the torque sensor measures raw data every 2 ms (i.e., 1250 values), shear rate: ramp 10-100 1/s logarithmic, measurement temperature: 60° C., trim position: 0.06 mm, measurement position: 0.05 mm).

The 15 data points are measured at the shear rates 10, 11.8, 13.9, 16.4, 19.3, 22.8, 26.8, 31.6, 37.3, 43.9, 51.8, 61.1, 72, 84.8, 100 [1/s], the value reported herein being that obtained at a shear rate of 100 [1/s].

### Determination of Iodine Number

The iodine number was determined by Kaufmann's method (DGF standard method C-V 11b). The iodine number is a measure of the level of unsaturated carbon-carbon double bonds. The determination is based on the ability of halogens (bromine in this case) to add onto double bonds. It is determined by backtitration of the unconsumed amount of halogen. It is expressed in g of iodine/100 g of substance.

1 g of sample is weighed out accurately to 0.001 g and after addition of 10 ml of 1:1 (v/v) cyclohexane/glacial acetic acid, is admixed with 25 ml of a bromine solution prepared from 120-150 g of sodium bromide (previously dried at 130° C.) in 1000 ml of methanol and 5.20 ml of bromine. Next 20 ml of aqueous potassium iodide solution (100 g/l of potassium iodide) and 100 ml of distilled water are added, and the released iodine is titrated with 0.1 mol/l of sodium thiosulfate solution initially to a yellow color, after addition of some aqueous starch solution (5 g/l starch) the then violet-black batch to the point of colorlessness.

### Determination of OH Number

The hydroxyl group content was determined by determining the “OH number” according to DIN 53240-2. To this end, all the OH groups were reacted with an excess of acetylating reagent (acetic anhydride) and the excess acid equivalents were determined by volumetric titration with potassium hydroxide solution. The OH number is that amount of potassium hydroxide in mg which is equivalent to the amount of acetic acid bound by 1 g of substance in the acetylation.

Determination of Functionality from Iodine Number and OH Number

The determination of the functionality from iodine number and OH number is described in N. Barksby, G. L. Allen, Polyurethane World Congress 1993, p. 445-450.

The synthesis of the polyester alcohol is accompanied by a secondary reaction which leads to the formation of polymer chains having a terminal allyl ether group, known as monools. The monool fraction present alongside the difunctional polyester alcohol leads to reduced functionality.

The monool content is determined by titrating the terminal double bond of the allyl group with mercuric acetate/alcoholic potassium hydroxide, i.e., by analyzing the level of unsaturation, expressed in milliequivalents per gram of polyol. From the degree of unsaturation (“unsat”=iodine number, in meq/g) and the hydroxyl number (“OH” in mg KOH/g), the functionality f can be calculated by applying the formula 1)

$$f = \frac{( \frac{OH}{56.1} )}{[ ( \frac{OH}{56.1} ) - unsat ] \cdot ( \frac{1}{{f}_{n}} ) + unsat} , \qquad ( 1 )$$

where fₙ is the nominal functionality for the polyester alcohol in consideration (for diols, i.e., in our case, fₙ=2). For a conventional polyester alcohol with a molecular weight Mn=4000, f is in the range of 1.7.
Water Content Determination after Karl Fischer (DIN EN 60814)

Water content was determined by Karl Fischer titration. To this end, from 1 to 3 ml of the sample solution were injected into an automat for determining the water content by the Karl Fischer method (Metrohm Karl Fischer Coulometer KF756). The measurement was done coulometrically and is based on the Karl Fischer reaction, the water-mediated reaction of iodine with sulfur dioxide.

### Determination of Color Number

Color number was determined according to ASTM D 4890 EN or DIN ISO 6271. The polymers freed of solvent were measured untreated in a LICO 200 liquid colorimeter from Dr. Lange. Precision cuvettes type No. 100-QS (path length 50 mm, from Helma) are used.

### Determination of Acid Number (DIN EN 12634)

The ester and carboxylic acid content of the starting materials (of the carboxyl groups present in the mixture) was determined by determining the “ester number” and the “acid number” by methods known to a person skilled in the art. To determine the acid number, all the carboxylic acids present were neutralized with an excess of potassium hydroxide and the remaining quantity of potassium hydroxide was determined by volumetric titration with hydrochloric acid. To determine the saponification number, all the esters present were saponified with an excess of ethanolic potassium hydroxide. The remaining quantity of potassium hydroxide was determined by volumetric titration with hydrochloric acid. The ester number is the difference between the saponification number thus determined and the previously determined acid number. The ester number is the amount of potassium hydroxide in mg which is equivalent to the amount of acetic acid bound by 1 g of substance in the acetylation.

### Isothermal Preparation of Prepolymer

The prepolymer was prepared isothermally at a temperature of 70° C. The molar ratio of polyester alcohol to 4,4′-diphenylmethane diisocyanate (MDI) was 1:2; the batch size was 350 g.

Polyesterol was initially charged to the reaction vessel at 70° C. and stirred. Exact temperature maintenance of +/−2° C. is of decisive importance.

The diphenylmethane diisocyanate (4,4-MDI) was added to the polyesterol and 5, 10, 15, 20, 25, 30, 35, 40, 50, 60, 70 and 80 min after MDI addition samples are taken from the reaction mixture and the NCO content determined by titration.

### NCO Titration (Isocyanate Content Determination)

A sample of the prepolymer was added to 30 ml of a mixture of dibutylamine and chlorobenzene where the dibutylamine concentration is 0.05 mol/l. Prior to addition of the prepolymer the blank value of the mixture was determined against 0.1 molar hydrochloric acid. The mixture including the sample is stirred for 10-15 min and subsequently admixed with 50 ml of ethanol. Unconverted dibutylamine is with 0.1 molar hydrochloric acid. From the consumption of the NCO content can be calculated by taking account of the blank value.

The faster the NCO concentration decreases with time, the higher the reactivity of the polyesterol.

### Example

### Example 1

### a) Preparing a Polyester Alcohol Mn 3000 g/mol (Inventive)

In a 4 l flask equipped with heating, stirring and distillation means, 375.4 g of isophthalic acid and 1956.08 g of polytetrahydrofuran 650 (denotes an average molecular weight of 650 g/mol) were in succession three times degassed, inertized with nitrogen and then heated to 180° C. under atmospheric pressure. The heating rate was adjusted such that the 180° C. came about after 2 hours.

The polycondensation ensued at a temperature of 180° C. under atmospheric pressure. This temperature was maintained for 3 h. This was followed by heating to 205° C., maintained for 2 h, and thereafter 220° C. After this temperature had been maintained for 3 h, 11.25 g (50 ppm) of tetrabutyl orthotitanate were added in the form of a 1% by weight solution in PTHF 650 before starting the vacuum phase. A vacuum of 20 mbar was applied. Water is distilled to reach an acid number of less than 1 in the course of 8 h.

On reaching the desired acid number, the system is cooled down to 190° C. To deactivate the catalyst 0.045 g (20 ppm, corresponding to a molar ratio of 1:1.18) of 85% by weight phosphoric acid was added. The batch was cooled down to room temperature and the quality of the polyester alcohol was tested via iodine number, color number, OH number, acid number, viscosity and water content.

| | |
|---|---|
| iodine number [g/100 g] | <0.1 |
| color number [Hazen] | 21 |
| OH number [g/100 g] | 37.38 |
| acid number [g/100 g] | 0.185 |
| viscosity [mPas, shear rate 100 [1/s], 60° C.] | 2840 |
| water content [ppm] | 86 |

### b) Preparing the Isocyanate-Terminated Prepolymer

The prepolymer was prepared at 70° C. under isothermal conditions.

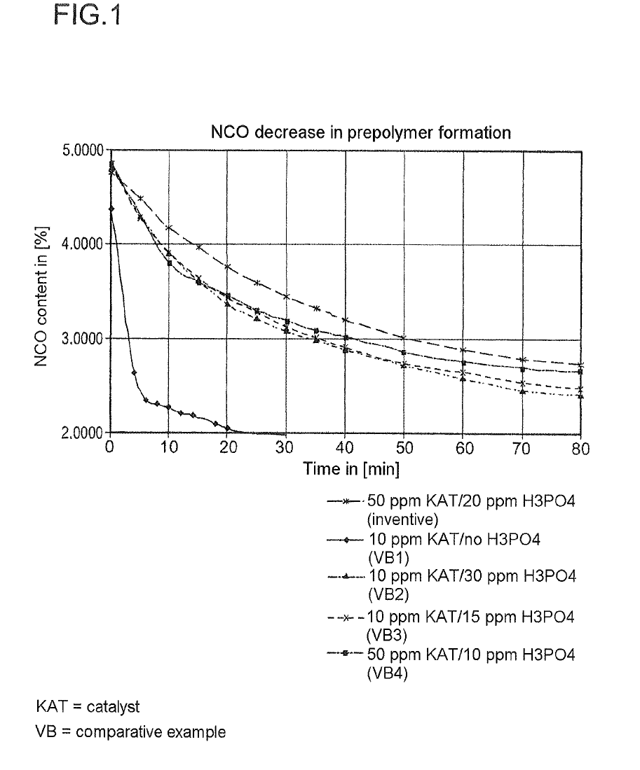

The result of the prepolymer test is shown in FIG. 1. The NCO concentration gradually decreases over time, indicating good deactivation of the polyesterol.

### Comparative Example 1 (VB 1) to Inventive Example

### Without Phosphoric Acid, with 10 ppm of Catalyst

a) Preparing a Polyester Alcohol Mn 3000 g/mol

In a 4 l flask equipped with heating, stirring and distillation means, 375.4 g of isophthalic acid and 1956.08 g of polytetrahydrofuran 650 (denotes an average molecular weight of 650 g/mol) were in succession three times degassed, inertized with nitrogen and then heated to 180° C. under atmospheric pressure. The heating rate was adjusted such that the 180° C. came about after 2 hours.

The polycondensation ensued at a temperature of 180° C. under atmospheric pressure. This temperature was maintained for 3 h. This was followed by heating to 205° C., maintained for 2 h, and thereafter 220° C. After this temperature had been maintained for 3 h, 2.25 g (10 ppm) of tetrabutyl orthotitanate were added in the form of a 1% by weight solution in PTHF 650 before starting the vacuum phase. A vacuum of 20 mbar was applied. Water is distilled to reach an acid number of less than 1 in the course of 22 h.

On reaching the desired acid number, the system is cooled down to room temperature and the quality of the polyester alcohol was tested via iodine number, color number, OH number, acid number, viscosity and water content.

| | |
|---|---|
| iodine number [g/100 g] | <0.1 |
| color number [Hazen] | 30 |
| OH number [g/100 g] | 37.12 |
| acid number [g/100 g] | 0.318 |
| viscosity [mPas, shear rate 100 [1/s], 60° C.] | 2960 |
| water content [ppm] | 92 |

### b) Preparing the Isocyanate-Terminated Prepolymer

The prepolymer was prepared at 70° C. under isothermal conditions. The decrease in NCO concentration over time is shown in FIG. 1. The distinctly faster drop in NCO concentration indicates an appreciably higher reactivity than in the inventive example.

### Comparative Example 2 (VB 2) to Inventive Example

### With 10 ppm of Catalyst and 30 ppm of H3PO4)

a) Preparing a Polyester Alcohol Mn 3000 g/mol

In a 4 l flask equipped with heating, stirring and distillation means, 375.4 g of isophthalic acid and 1956.08 g of polytetrahydrofuran 650 (denotes an average molecular weight of 650 g/mol) were in succession three times degassed, inertized with nitrogen and then heated to 180° C. under atmospheric pressure. The heating rate was adjusted such that the 180° C. came about after 2 hours.

The polycondensation ensued at a temperature of 180° C. under atmospheric pressure. This temperature was maintained for 3 h. This was followed by heating to 205° C., maintained for 2 h, and thereafter 220° C. After this temperature had been maintained for 3 h, 2.25 g (10 ppm) of tetrabutyl orthotitanate were added in the form of a 1% by weight solution in PTHF 650 before starting the vacuum phase. A vacuum of 20 mbar was applied. Water is distilled to reach an acid number of less than 1 in the course of 22 h.

On reaching the desired acid number, the system is cooled down to 190° C. To deactivate the catalyst 0.0675 g (30 ppm, corresponding to a molar ratio of 1:8.8) of 85% by weight phosphoric acid was added. The batch was cooled down to room temperature and the quality of the polyester alcohol was tested via iodine number, color number, OH number, acid number, viscosity and water content.

| | |
|---|---|
| iodine number [g/100 g] | <0.1 |
| color number [Hazen] | 20 |
| OH number [g/100 g] | 37.23 |
| acid number [g/100 g] | 0.349 |
| viscosity [mPas, shear rate 100 [1/s], 60° C.] | 3150 |
| water content [ppm] | 123 |

### b) Preparing the Isocyanate-Terminated Prepolymer

The prepolymer was prepared at 70° C. under isothermal conditions. The decrease in NCO concentration over time is shown in FIG. 1. The distinctly faster drop in NCO concentration indicates a higher reactivity than in the inventive example.

### Comparative Example 3 (VB 3) to Inventive Example

### With 10 ppm of Catalyst and 15 ppm of H3PO4

a) Preparing a Polyester Alcohol Mn 3000 g/mol (LJ843)

In a 4 l flask equipped with heating, stirring and distillation means, 375.4 g of isophthalic acid and 1956.08 g of polytetrahydrofuran 650 (denotes an average molecular weight of 650 g/mol) were in succession three times degassed, inertized with nitrogen and then heated to 180° C. under atmospheric pressure. The heating rate was adjusted such that the 180° C. came about after 2 hours.

The polycondensation ensued at a temperature of 180° C. under atmospheric pressure. This temperature was maintained for 3 h. This was followed by heating to 205° C., maintained for 2 h, and thereafter 220° C. After this temperature had been maintained for 3 h, 2.25 g (10 ppm) of tetrabutyl orthotitanate were added in the form of a 1% by weight solution in PTHF 650 before starting the vacuum phase. A vacuum of 20 mbar was applied. Water is distilled to reach an acid number of less than 1 in the course of 8 h.

On reaching the desired acid number, the system is cooled down to 190° C. To deactivate the catalyst 0.0338 g (15 ppm, corresponding to a molar ratio of 1:4.5) of 85% by weight phosphoric acid was added. The batch was cooled down to room temperature and the quality of the polyester alcohol was tested via iodine number, color number, OH number, acid number, viscosity and water content.

| | |
|---|---|
| iodine number [g/100 g] | <0.1 |
| color number [Hazen] | 28 |
| OH number [g/100 g] | 37.38 |
| acid number [g/100 g] | 0.128 |
| viscosity [mPas, shear rate 100 [1/s], 60° C.] | 2920 |
| water content [ppm] | 69 |

### b) Preparing the Isocyanate-Terminated Prepolymer

The prepolymer was prepared at 70° C. under isothermal conditions. The decrease in NCO concentration over time is shown in FIG. 1. The distinctly faster drop in NCO concentration indicates a higher reactivity than in the inventive example.

### Comparative Example 4 (VB 4) to Inventive Example

### With 50 ppm of Catalyst and 10 ppm of H3PO4

a) Preparing a Polyester Alcohol Mn 3000 g/mol

In a 4 l flask equipped with heating, stirring and distillation means, 375.4 g of isophthalic acid and 1956.08 g of polytetrahydrofuran 650 (denotes an average molecular weight of 650 g/mol) were in succession three times degassed, inertized with nitrogen and then heated to 180° C. under atmospheric pressure. The heating rate was adjusted such that the 180° C. came about after 2 hours.

The polycondensation ensued at a temperature of 180° C. under atmospheric pressure. This temperature was maintained for 3 h. This was followed by heating to 205° C., maintained for 2 h, and thereafter 220° C. After this temperature had been maintained for 3 h, 11.25 g (50 ppm) of tetrabutyl orthotitanate were added in the form of a 1% by weight solution in PTHF 650 before starting the vacuum phase. A vacuum of 20 mbar was applied. Water is distilled to reach an acid number of less than 1 in the course of 8 h.

On reaching the desired acid number, the system is cooled down to 190° C. To deactivate the catalyst 0.0225 g (10 ppm, corresponding to a molar ratio of 1:0.6) of 85% by weight phosphoric acid was added. The batch was cooled down to room temperature and the quality of the ester was tested via iodine number, color number, OH number, acid number, viscosity and water content.

| | |
|---|---|
| iodine number [g/100 g] | <0.1 |
| color number [Hazen] | 32 |
| OH number [g/100 g] | 37.41 |
| acid number [g/100 g] | 0.180 |
| viscosity [mPas, shear rate 100 [1/s], 60° C.] | 2990 |
| water content [ppm] | 79 |

### b) Preparing the Isocyanate-Terminated Prepolymer

The prepolymer was prepared at 70° C. under isothermal conditions.

The decrease in NCO concentration over time is shown in FIG. 1. The distinctly faster drop in NCO concentration indicates a higher reactivity than in the inventive example.

1-10. (canceled)

11. A process for preparing polyester alcohols by condensation of polytetrahydrofuran with aromatic dicarboxylic acids and/or their anhydrides and/or their esters in the presence of a transesterification catalyst in a multi-stage operation at different pressure levels with at least one reaction stage at atmospheric pressure and at least one reaction stage at reduced pressure, where distillate is removed from the reaction system, which process comprises deactivating the catalyst after the polycondensation by using phosphoric acid in a molar ratio of 1:1 to 1:3.5 for catalyst to phosphoric acid.

12. The process according to claim 11 wherein phosphoric acid is used in a molar ratio of 1:1 to 2:4 for catalyst to phosphoric acid.

13. The process according to claim 11 wherein phosphoric acid is used in a molar ratio of 1:1 to 1:1.4 for catalyst to phosphoric acid.

14. The process according to claim 11 wherein the catalyst used is tetrabutyl orthotitanate, tetraisopropyl orthotitanate, dibutyltin laurate, dibutyltin oxide, tin dioctoate, tin chloride, tin oxide, potassium hydroxide, sodium methoxide, titanium zeolites, lipases and/or hydrolases in a concentration of 3 to 100 ppm.

15. The process according to claim 11 wherein the catalyst used is titanium tetrabutoxide in polytetrahydrofuran having an average molecular weight of 250 to 1000 daltons and/or 1,4-butanediol as solvent.

16. The process according to claim 11 wherein polytetrahydrofuran is reacted with isophthalic acid in the presence of tetrabutyl orthotitanate and the reaction mixture is heated in two or more phases in the atmospheric-pressure reaction stage wherein the heating phases are interrupted by at least one phase in which the temperature is kept constant.

17. The process according to claim 11 wherein the reaction mixture in the first heating phase is heated to a temperature T₁ where T₁=130 to 190° C. in the course of 0.1 to 15 h.

18. The process according to claim 11 wherein the reaction mixture in the second heating phase is heated to a temperature Tₑ=200 to 230° C. in the course of 3 to 12 h.

19. The process according to claim 11 wherein the temperature is twice kept constant between the heating phases.

20. The process according to claim 11 wherein the reduced-pressure reaction stage is carried out at a pressure in the range from less than 1013 to 5 hPa.
